(19) United States
(12) Patent Application Publication
(10) Pub. No.: US 2015/0332616 A1
(43) Pub. Date: Nov. 19, 2015

(54) SHELF DISPLAY

(71) Applicant: One Source Industries, LLC, Irvine, CA (US)

(72) Inventor: Richard A. Ports, San Clemente, CA (US)

(21) Appl. No.: 14/710,890

(22) Filed: May 13, 2015

Related U.S. Application Data
(60) Provisional application No. 61/996,682, filed on May 14, 2014.

(51) Int. Cl. G09F 7/18; F16M 13/02; G09F 13/22; A47F 5/00

(52) U.S. Cl. CPC G09F 7/18; A47F 5/0018; F16M 13/022; G09F 13/22; G09F 2007/1852; G09F 2013/222

(57) ABSTRACT

A point-of-purchase shelf display fixture that is easily attached to a store merchandising fixture in a retail or wholesale environment is disclosed. It extends perpendicularly from a merchandising fixture to increase visibility. The display may be formed in multiple sizes and shapes, and is oriented so that both sides of the shelf display can be used for graphic statements. The display is attached to a horizontal or vertical portion of the merchandising fixture using magnets or other types of attachment devices.

### PRIORITY

The application claims priority to Provisional Application No. 61/996,682 filed May 14, 2014.

### BACKGROUND

The invention relates generally to advertising devices and more particularly to point-of-purchase shelf displays.

Marketers are always looking for ways to gain a consumer's attention. Retail establishments use a variety of displays to present products, coupons or information about products to consumers in order to encourage the consumer to make a purchase. One technique is known as a point-of-purchase display, where information about a product is located on a shelf or merchandising fixture close to where the product is available for purchase. Locating the display at the point where a customer is making a decision on whether or not to purchase a product can be a highly effective way to drive product sales.

Prior art displays suffer from a variety of drawbacks. Some are installed flat against the merchandising fixture and can be easily missed by consumers traveling through a store. Others have cumbersome installation techniques that require extra time on the part of store employees to install. Others are difficult to update with new advertising materials.

Thus, a need exists for point-of-purchase shelf displays that attract a consumer's attention and are easy to install and maintain.

### SUMMARY

The invention in one implementation encompasses an apparatus. The apparatus comprises a point-of-purchase shelf display fixture that is easily attached to a store merchandising fixture in a retail or wholesale environment. It extends perpendicularly from the shelf to increase visibility. The display may be formed in multiple sizes and shapes, and is oriented so that both sides of the shelf display can be used for graphic statements. This type of display is also known as an aisle violator or aisle invader because it extends from a merchandising fixture, or gondola, into the aisle.

In an embodiment, the shelf display fixture is attached magnetically so it can be quickly installed on a wide variety of shelving units without the use of extra hardware or tools. The magnetic attachment mechanism allows the fixture to be easily installed and repositioned. In the inventive shelf display, ads and graphics are also easy to interchange and update as needed.

Advantageously, the shelf display fixture is provided with several configurations of LED that further attract consumers' attention as they approach the product. The LEDs may be activated by motion sensors to conserve energy and save battery life.

In an embodiment, a shelf display according to the present invention includes first and second substantially planar frames each having an inner edge and an outer edge, said inner edge forming an opening in each of said frames, sidewalls integrally formed with and perpendicular to the first and second frames, said sidewalls attaching the first and second frames to each other on approximately three quarters of the outer edges of said frames so that the frames are held at a distance from each other of approximately 0.15 to 0.4 inches, the remainder of the outer edges forming a slot for insertion of graphic material, an arm integrally attached the sidewall in a location substantially adjacent to or opposite from the slot, said arm extending away from the sidewall in the same plane as the first and second frames, a mounting assembly integrally formed with and attached to the opposite end of the arm, said mounting assembly further comprising a planar shape disposed perpendicularly to the length of the arm and one or more rare earth magnets attached to the mounting assembly, whereby the shelf display is attached to a merchandising fixture.

In a further embodiment, the invention encompasses an aisle violator display assembly for attachment to an existing merchandising fixture having horizontal shelves and vertical supports, which includes first and second rectangular frames each having an inner edge and an outer edge, said inner edge forming an opening in each of said frames, sidewalls integrally formed with and perpendicular to the first and second frames, said sidewalls attaching the first and second frames to each other on three sides of the outer edges of said frames so that the frames are held at a distance from each other of approximately 0.15 to 0.4 inches, the remaining side of the outer edges forming a slot for insertion of graphic material, an arm integrally attached the sidewall adjacent to the upper edge, said arm extending away from the sidewall in the same plane as the first and second frames, a mounting assembly integrally formed with and attached to the opposite end of the arm, said mounting assembly further comprising a planar shape disposed perpendicularly to the length of the arm and one or more rare earth magnets attached to the mounting assembly, whereby the aisle violator display assembly is attached to either horizontal shelves or vertical supports of the merchandising fixture and extends perpendicularly from the merchandising fixture into an aisle.

In either of the above embodiments, the first and second frames are rectangular, the slot is located in an upper edge of said frames and the arm is integrally attached to a sidewall adjacent to said upper edge so that, when attached to a merchandising fixture, the shelf display extends perpendicularly from the merchandising fixture.

In either of the above embodiments, a generally C-shaped slot is formed by the attachment of the sidewalls and first and second frames adjacent to the slot and extending to edge of the frames opposite the slot so that graphic material is retained between the frames.

As an alternative, the arm is straight and the length of the arm extends perpendicularly away from the sidewall. Additionally, the length of the arm may vary in length. Further the arm may be curved and attached at a lower edge of the first and second frames such that it curves towards the top edge of the frames.

In either of the above embodiments, the plane of the mounting assembly may be horizontal and equivalent to the plane of a shelf of the merchandising fixture, and wherein the one or more rare earth magnets attach to an underside of the shelf.

In a further embodiment, the graphic material is visible through the openings in both of the first and second frames. One or more LEDs may be incorporated in said frame or graphic material, said one or more LEDs may be activated by a motion sensor.

In either of the above embodiments, the arm is less than 1″ long and is attached to a corner of said first and second frames, and wherein the plane of the mounting assembly is at an angle to the outer edges of the frame so that the shelf display rests on top of a merchandising fixture.

### DESCRIPTION OF THE DRAWINGS

Features of example implementations of the invention will become apparent from the description, the claims, and the accompanying drawings in which:

FIG. 1 is a perspective view of an exemplary shelf display fixture under one embodiment.

FIGS. 2A and 2B are side and front views of the shelf display fixture of FIG. 1.

FIG. 3 is a perspective view of an exemplary shelf display fixture in a further embodiment.

FIGS. 4A and 4B are side and front views of the shelf display fixture of FIG. 3.

FIGS. 5A and 5B are alternative embodiments of the shelf display fixture of FIG. 3.

FIG. 6 is a perspective view an exemplary shelf display fixture in a further embodiment.

FIG. 7 is a perspective view an exemplary shelf display fixture in another embodiment.

FIGS. 8A-8D are front, side, back and top views of the shelf display fixture of FIG. 7.

FIG. 9 is an exploded view of another embodiment of the shelf display fixture of FIG. 7.

### DETAILED DESCRIPTION

If used and unless otherwise stated, the terms “upper,” “lower,” “front,” “back,” “over,” “under,” and similar such terms are not to be construed as limiting the invention to a particular orientation. Instead, these terms are used only on a relative basis.

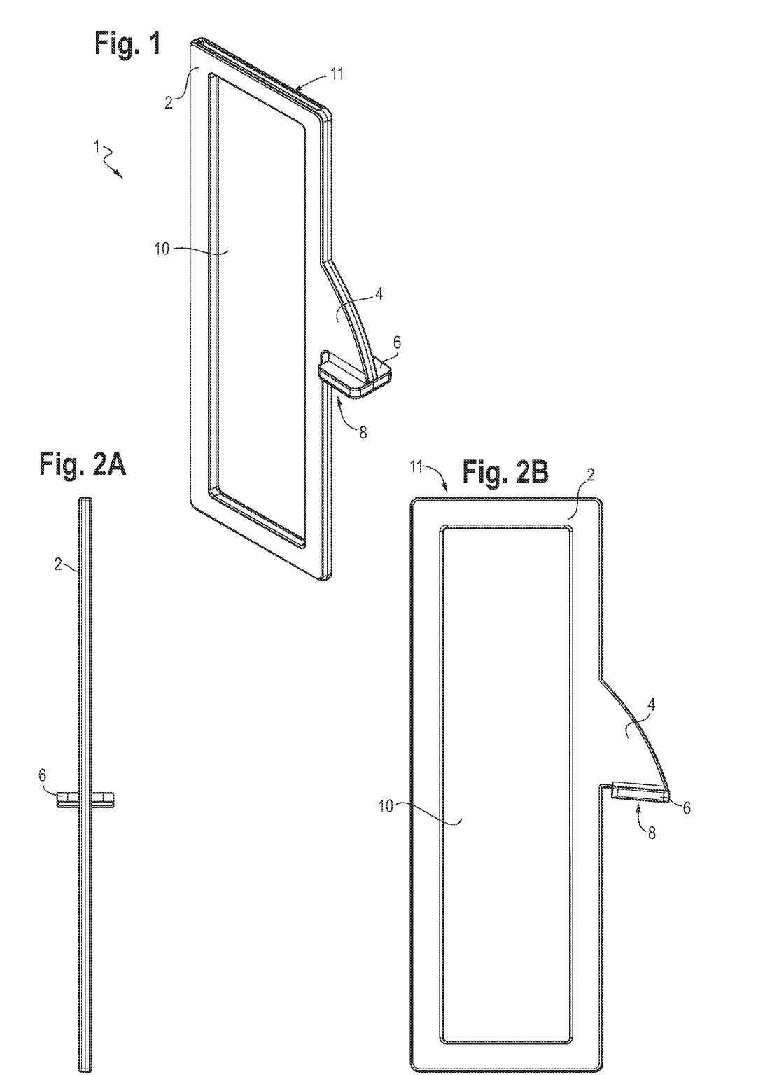

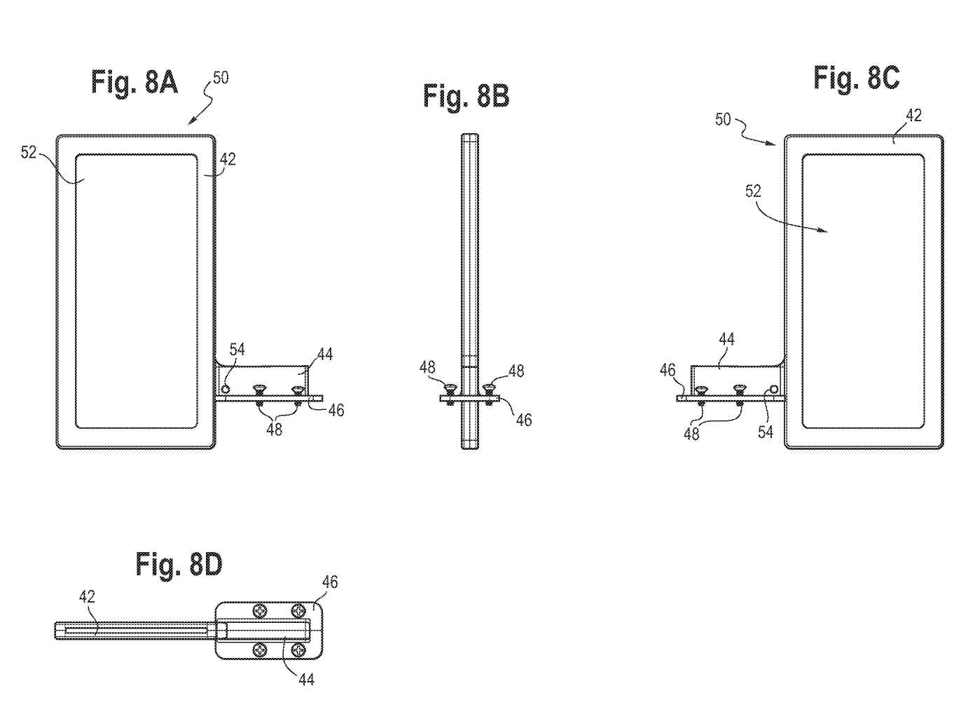

Turning to FIGS. 1 and 2A-2B, shelf display fixture 1 in a first embodiment of the invention includes a frame 2 and arm 4. Arm 4 is parallel to frame 2 and extends outwardly from one side of frame 2. Mounting assembly 6 extends from either side of arm 4. In an embodiment, frame 2, arm 4 and mounting assembly 6 are integrally formed, for example, using a process of injection molding, vacuum forming, etc. Suitable materials include, for example, ABS (acrylonitrile butadiene styrene) or other styrenes, polypropylene, polyurethane, polycarbonate, acrylic, etc. In an embodiment, shelf mounting assembly 6 includes one or more rare earth magnets, for example, neodymium magnets, attached to surface 8, enabling fixture 1 to be easily attached to the top of a wide variety of shelving units so that frame 2 extends perpendicularly away from the shelf. As an alternative, fixture 1 can be attached to a shelf using screws, pins, etc. This alternative is shown in more detail in FIG. 8. Frame 2 features a display area 10 that is visible from both sides of shelf display 1. Graphic material may be inserted into slot 11 on top of frame 2 and is visible from both sides of fixture 1. Alternatively, slot 11 may also be located on a side of frame 2 that is opposite arm 4. A generally C-shaped channel (not shown) extends along the inside length of each side of frame 2 so that graphic material inserted through slot 11 is held securely inside frame 2. If slot 11 is located in the side of frame 2, the C-shaped channel would extend along the top and bottom of frame 2.

In an embodiment, frame 2 has inside dimensions of approximately 13″×3.3″ and outside dimensions of approximately 14.3″×5″. Mounting assembly 6 is located approximately 7.5″ below the top of frame 2 and the overall width of frame 2 and arm 4 together is approximately 6.3″. The thickness of frame 2 is approximately 0.25″. The above dimensions are representative and any desired dimensions that meet display, shelving or space requirements can be used.

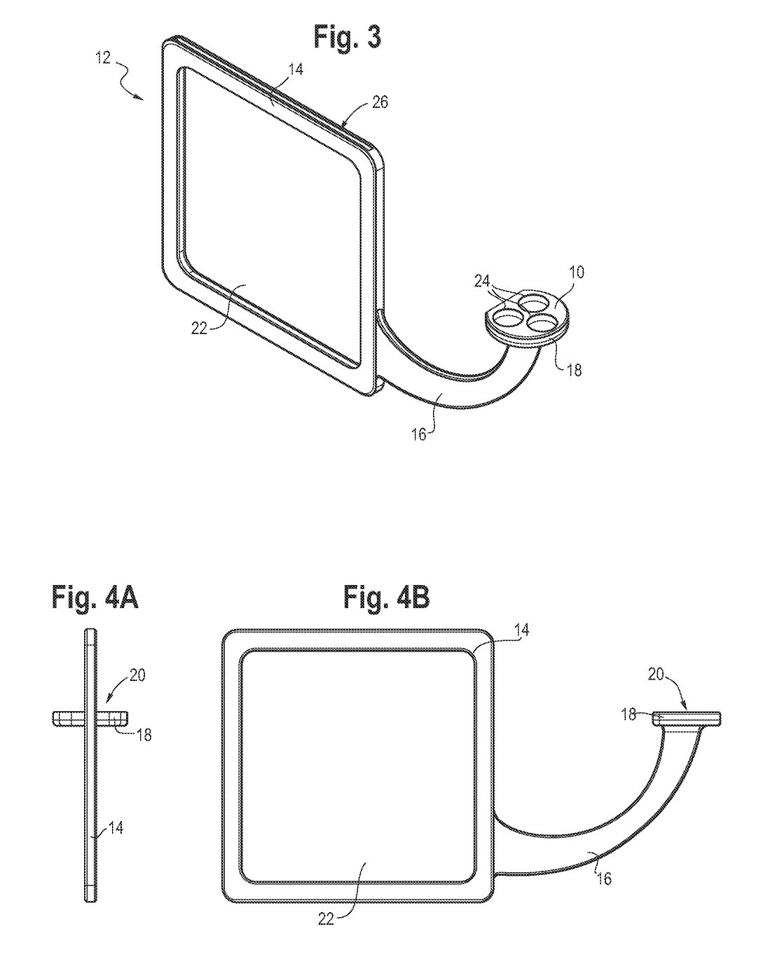

In the embodiment shown in FIGS. 3 and 4A-4B, a shelf display fixture 12 includes a frame 14 and arm 16 which extends from one side in the same plane as frame 14. Mounting assembly 18 extends from either side of shelf arm 16. Frame 14, arm 16 and mounting assembly 18 are integrally formed as described above for the embodiment of FIG. 1. Surface 20 includes one or more recessed areas 24 for holding rare earth magnets, for example, neodymium magnets, (not shown) used to attach shelf display 12 to the underside of a shelf. Although three recessed areas 24 are shown, any desired number of magnets may be used. As an alternative, screws or pins could be used to attach shelf display fixture 12 to a shelf. A display area 22 is featured on both sides of fixture 12. Graphics are inserted into slot 26 which is shown on top of frame 14 but could also be located along the side of frame 14. As in the embodiment of FIGS. 1 and 2, this embodiment is preferably manufactured from, for example, ABS (acrylonitrile butadiene styrene) or other styrenes, polypropylene, polyurethane, polycarbonate, acrylic, etc.

In an embodiment, frame 14 has inside dimensions of approximately 4.25″×4.25″ and outside dimensions of approximately 5″×5″. Mounting assembly 18 is located approximately 1″ below the top of frame 14 and the overall width of frame 14 and arm 16 is approximately 9″. The thickness of frame 14 is approximately 0.20″ and the thickness of mounting assembly 18 is approximately 1.3″. The above dimensions are representative and any desired dimensions that meet display and space requirements can be used. For example, arm 16 could be located in any position along the side of frame 14.

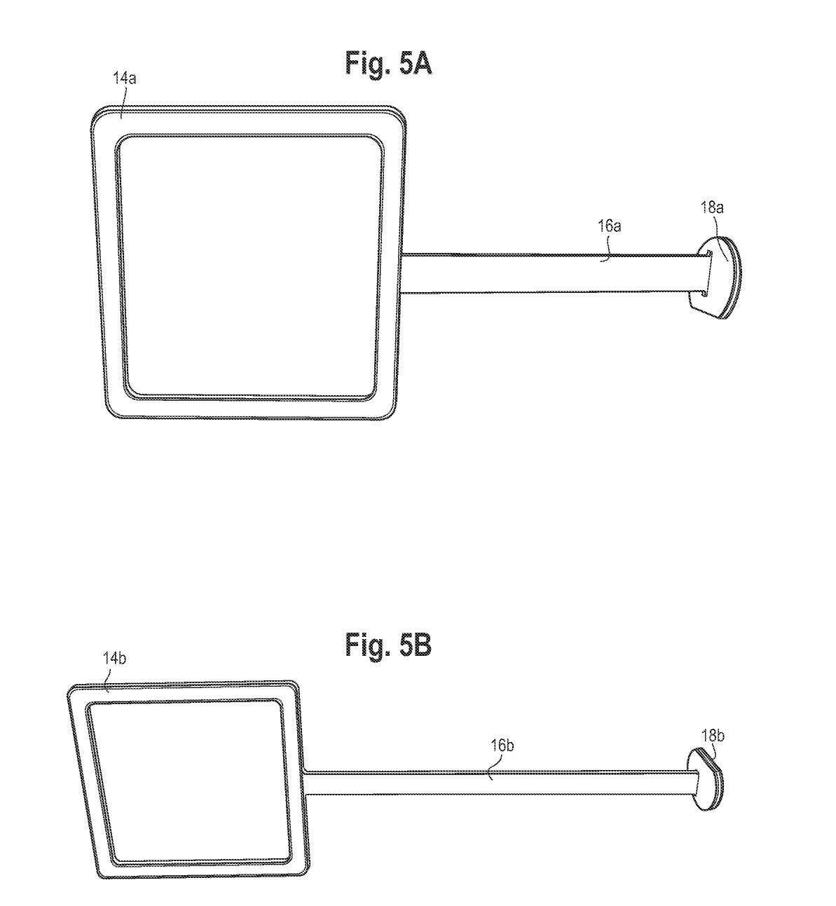

An alternative embodiment of arm 16 of FIG. 3 is shown in FIG. 5A. In this embodiment, arm 16a extends perpendicularly from frame 14a. Mounting assembly 18a is attached vertically to the end of arm 16a opposite frame 14a. This embodiment allows a shelf display fixture to be attached to either horizontal or vertical portions of a merchandising fixture. The length of arm 16a may be adjusted to meet display, shelving or space requirements as needed. For example, in FIG. 5A, arm 16a is approximately 5″ long. In FIG. 5B, arm 16b is approximately 9″ long. Mounting assemblies 18a and 18b may also be attached to arms 16a and 16b in a variety of orientations, as shown. As for the other embodiments, the dimensions are representative and any desired dimensions that meet display and space requirements can be used. Arm 16a/16b can also be located in any position along the edge of frame 14a/14b.

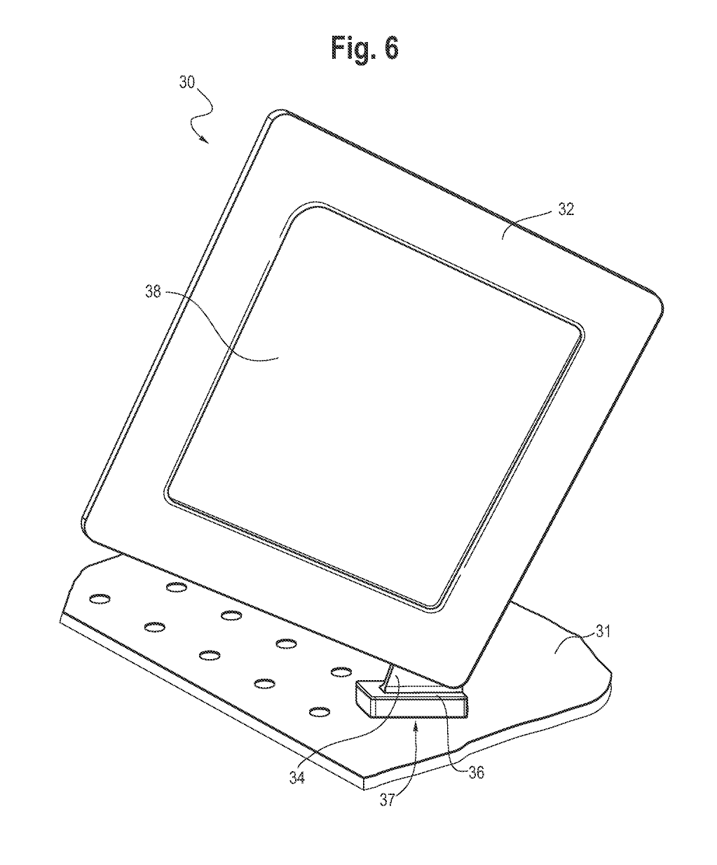

In the embodiment of FIG. 6, a shelf display fixture 30 is mounted on top of shelf 31 similarly to shelf display fixture 1 of FIG. 1. Frame 32 holds graphics in display area 38, the graphics appearing on both sides of frame 32. Arm 36 is formed at a corner of frame 32 so that frame 32 forms an angle of approximately 15°-45° with shelf 31. As with shelf display fixture 1, mounting assembly 36 extends from either side of arm 36 and includes a surface 37 for holding rare earth magnets, for example, neodymium magnets (not shown), used to secure shelf display 30 to shelf 31. As an alternative, screws or pins could be used to attach shelf display fixture 30 to shelf 31. Fixture 30 has dimensions of approximately 5″×5″ but any desired dimensions that meet display and space requirements can be used. As in the embodiment of FIGS. 1 and 3, this embodiment is preferably manufactured, for example, using a process of injection molding, vacuum forming, etc. Suitable materials include ABS (acrylonitrile butadiene styrene) or other styrenes, polypropylene, polyurethane, polycarbonate, acrylic, etc. In addition, a different mounting mechanism could be used.

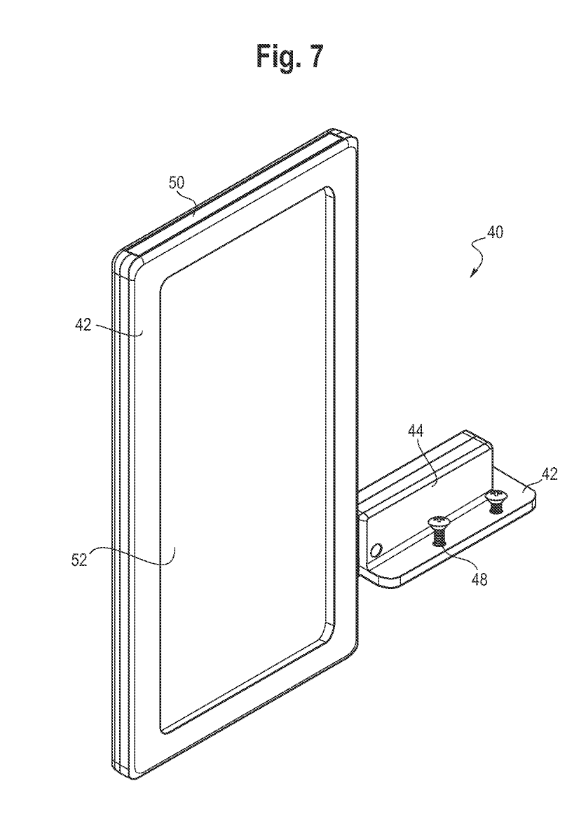

In the embodiment of FIGS. 7 and 8A-8D, a shelf display fixture 40 includes frame 42 and arm 44. Mounting assembly 46 extends from either side of arm 44 and includes one or more screws 48 to attach fixture 40 to the top surface of a shelf. As an alternative, fixture 40 could be attached to a shelf using magnets as described for the embodiments of FIGS. 1, 3 and 6. The top of frame 42 includes a slot 50 for sliding graphics into frame 42 for display in the area marked as 52. In an alternative, slot 50 could be located along the side of frame 42. Graphic material can be displayed on both sides of fixture 40. As described above, this embodiment is preferably manufactured, for example, using a process of injection molding, vacuum forming, etc. Suitable materials include ABS (acrylonitrile butadiene styrene) or other styrenes, polypropylene, polyurethane, polycarbonate, acrylic, etc.

In an embodiment, frame 42 has inside dimensions of approximately 3″×7″ and outside dimensions of approximately 4″×8″. Mounting assembly 46 is approximately 2.75″×1.5″. The thickness of frame 14 is approximately 0.50″. The above dimensions are representative and any desired dimensions that meet display and space requirements can be used.

In a further embodiment, shelf display fixture 40 of FIG. 7 is used with a lighted display. In this embodiment, motion sensors 54 are included on one or both sides of arm 44 (as shown in FIGS. 8A and 8C). As an alternative, motion sensors 54 can also be located within frame 42.

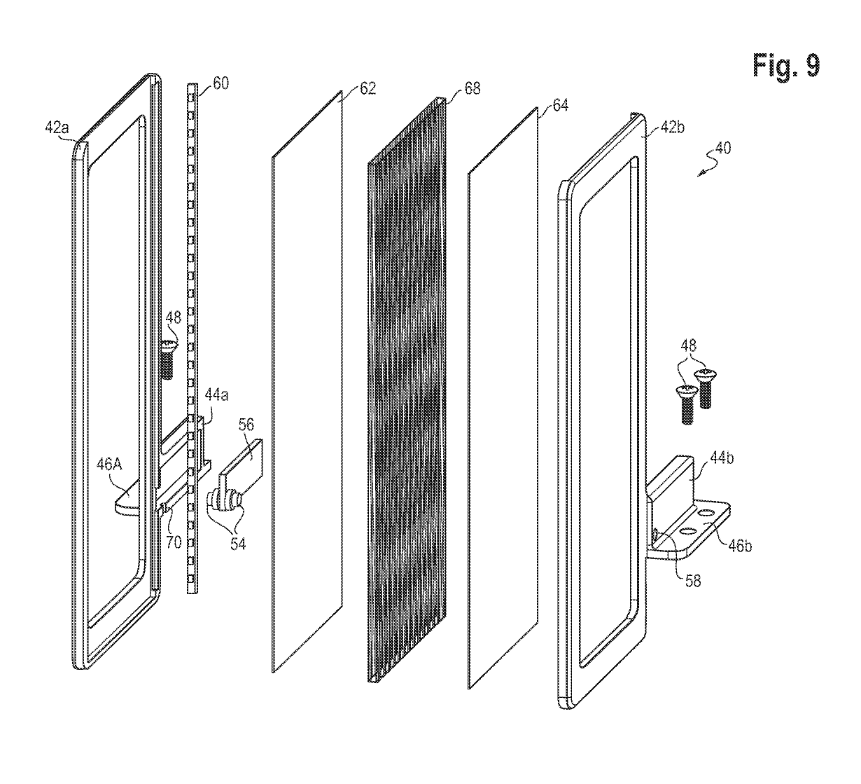

A representative lighted display according to this embodiment is shown in an exploded view in FIG. 9. Frame 42 is shown in two halves at 42a and 42b, together with arm 44a, 44b and mounting assembly 46a, 46b. A strip of LEDs 60 is installed along one vertical edge of frame 42 for providing light to fixture 40. Translucent panels 62 and 64 printed with advertising graphics and are located next to frame 42a and 42b respectively. Grooved acrylic light refractor panel 68 is positioned between acrylic panels 62 and 64 to provide an even lighting of panels 62 and 64. Motion sensors 54 are held in place by tab 56 which fits into recessed areas of arm 44a, 44b. Motion sensors 54 are inserted through holes 58 when the shelf display is assembled. As mentioned above, motion sensors 54 can also be located in frame 42. A battery pack (not shown) connects to fixture 40 through an opening 70 in mounting assembly 46a, although any preferred location could be used. The battery pack connects to fixture 40 through wires of a length sufficient to allow the battery pack to be positioned away from the edge of a shelf. It can be mounted on the top or underside of a shelf, may use any desired size of battery and may also be provided with an on/off switch as required.

LEDs 60 and light refractor panel 68 are used interchangeably with multiple translucent panels 62 and 64 so that advertising graphics can be changed as required. In an alternative embodiment, fixture 40 is provided with an audio component, for example, a speaker, to further attract a consumer's attention to the displayed graphic. A speaker could be installed in fixture 40 of FIG. 9 in a manner similar to that of motion sensors 54.

The graphic material, or advertising content, displayed in any of the frames of the present invention may take a variety of forms. The graphic material may be printed in paper, cardstock or something similar. One or more steady-state or flashing LEDs, which may also be motion-activated, may be attached to the graphic material. Further, graphic material incorporating lenticular printing, where the image changes based on viewing angle, may also be used. Graphic content for the frames of the invention may also be provided by a programmable digital display inserted into or integrally formed with any of the frames.

The installation of any of the shelf display fixtures described above is quick and convenient. Fixtures using a magnetic method of attachment are installed by simply inserting suitable graphics into the slot in the frame and setting the fixture in a preferred location on a shelf. Embodiments using screws or other means of attachment are similarly installed as appropriate.

Numerous alternative implementations of the present invention exist. For example, the dimensions and shapes of the various embodiments of the shelf display fixtures can be varied according to display needs, space available and customer preference. Also, the method of attaching the shelf display fixtures to a shelf can be varied to adapt to different kinds of shelves. Additionally, LEDs can be used in any of the frames of the various embodiments for further attract attention, as well as in the inserted graphics themselves. LEDs may be motion activated, steady state or blinking, and powered by a watch battery or any preferred power source. Any preferred method of printing or developing graphics on paper-based or acrylic-based media can be used. In another alternative, any of the frames above may be molded to include an imprint of a brand identity or other information.

The steps or operations described herein are just for example. There may be many variations to these steps or operations without departing from the spirit of the invention. For instance, the steps may be performed in a differing order, or steps may be added, deleted, or modified.

Although example implementations of the invention have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

What is claimed is:

1. A shelf display for attachment to a merchandising fixture, the shelf display comprising:
first and second substantially planar frames each having an inner edge and an outer edge, said inner edge forming an opening in each of said frames;
sidewalls integrally formed with and perpendicular to the first and second frames, said sidewalls attaching the first and second frames to each other on approximately three quarters of the outer edges of said frames so that the frames are held at a distance from each other of approximately 0.15 to 0.4 inches, the remainder of the outer edges forming a slot for insertion of graphic material;
an arm integrally attached the sidewall in a location substantially adjacent to or opposite from the slot, said arm extending away from the sidewall in the same plane as the first and second frames;
a mounting assembly integrally formed with and attached to the opposite end of the arm, said mounting assembly further comprising a planar shape disposed perpendicularly to the length of the arm; and
one or more rare earth magnets attached to the mounting assembly, whereby the shelf display is attached to a merchandising fixture.

2. The shelf display of claim 1, wherein the first and second frames are rectangular, the slot is located in an upper edge of said frames and the arm is integrally attached to a sidewall adjacent to said upper edge so that, when attached to a merchandising fixture, the shelf display extends perpendicularly from the merchandising fixture.

3. The shelf display of claim 1, wherein a generally C-shaped slot is formed by the attachment of the sidewalls and first and second frames adjacent to the slot and extending to edge of the frames opposite the slot so that graphic material is retained between the frames.

4. The shelf display of claim 1, wherein the arm is straight and the length of the arm extends perpendicularly away from the sidewall.

5. The shelf display of claim 3, wherein the length of the arm is less than approximately 9″ long.

6. The shelf display of claim 1, wherein the arm is curved and attached at a lower edge of the first and second frames such that it curves towards the top edge of the frames.

7. The shelf display of claim 5, wherein the plane of the mounting assembly is horizontal and equivalent to the plane of a shelf of the merchandising fixture, and wherein the one or more rare earth magnets attach to an underside of the shelf.

8. The shelf display of claim 1 wherein the graphic material is visible through the openings in both of the first and second frames.

9. The shelf display of claim 1, further comprising:
one or more LEDs in said frame or graphic material, said one or more LEDs activated by a motion sensor.

10. The shelf display of claim 1, wherein the arm is less than 1″ long and is attached to a corner of said first and second frames, and wherein the plane of the mounting assembly is at an angle to the outer edges of the frame so that the shelf display rests on top of a merchandising fixture.

11. An aisle violator display assembly for attachment to an existing merchandising fixture having horizontal shelves and vertical supports, comprising:
first and second rectangular frames each having an inner edge and an outer edge, said inner edge forming an opening in each of said frames;
sidewalls integrally formed with and perpendicular to the first and second frames, said sidewalls attaching the first and second frames to each other on three sides of the outer edges of said frames so that the frames are held at a distance from each other of approximately 0.15 to 0.4 inches, the remaining side of the outer edges forming a slot for insertion of graphic material;
an arm integrally attached the sidewall adjacent to the upper edge, said arm extending away from the sidewall in the same plane as the first and second frames;
a mounting assembly integrally formed with and attached to the opposite end of the arm, said mounting assembly further comprising a planar shape disposed perpendicularly to the length of the arm; and
one or more rare earth magnets attached to the mounting assembly, whereby the aisle violator display assembly is attached to either horizontal shelves or vertical supports of the merchandising fixture and extends perpendicularly from the merchandising fixture into an aisle.

12. The aisle violator display assembly of claim 11, wherein a generally C-shaped slot is formed along the sidewalls between first and second frames adjacent to the slot and extending to bottom edge of the assembly so that graphic material is retained between the frames.

13. The aisle violator display assembly of claim 11, wherein the length of the arm extends perpendicularly away from the sidewall.

14. The aisle violator display assembly of claim 13, wherein the length of the arm is less than approximately 9″ long.

15. The aisle violator display assembly of claim 11, wherein the arm is curved and attached at a lower edge of the first and second frames such that it curves towards the top of the frames.

16. The aisle violator display assembly of claim 15, wherein the plane of the mounting assembly is horizontal and the one or more rare earth magnets attach to an underside of the horizontal shelf of said merchandising fixture.

17. The aisle violator display assembly of claim 11 wherein the graphic material is visible through the openings in both of the first and second frames.

18. The aisle violator display assembly of claim 11, further comprising:
one or more LEDs in said frame or graphic material, said one or more LEDs activated by a motion sensor.

19. The aisle violator display assembly of claim 11, wherein the arm is less than 1″ long and is attached to a corner of said first and second frames, and wherein the plane of the mounting assembly is at an angle to the outer edges of the frame so that the shelf display rests on top of a merchandising fixture.
